(19) United States
(12) Patent Application Publication
(10) Pub. No.: US 2008/0026127 A1
(43) Pub. Date: Jan. 31, 2008

(54) Frozen Confectionery Product Comprising Ice Structuring Proteins

(76) Inventors: Nigel Malcolm Lindner, Shambrook (GB); Jon Richard Oldroyd, Green Bay, WI (US); Andrew Sztehlo, Shanghai (CN); Deborah Jane Towell, Shambrook (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/582,278

(22) PCT Filed: Sep. 20, 2004
(86) PCT No.: PCT/EP04/10630

§ 371 Date: Aug. 13, 2007

(30) Foreign Application Priority Data
Dec. 10, 2003 (EP) 03257755.3

(51) Int. Cl. A23G 3/00; A23C 13/14

(52) U.S. Cl. 426/586; 426/660

(57) ABSTRACT

A frozen confectionery product is provided comprising a plurality of discrete unaerated dairy frozen confections, each discrete frozen confection being able to contact directly other discrete frozen confections in the product, which frozen confections comprise an ice structuring protein (ISP) and have an average volume of less than 1 ml.

### FIELD OF THE INVENTION

The present invention relates to frozen dairy confectionery products which comprise a plurality of individual confections and which contain ice structuring proteins.

### BACKGROUND TO THE INVENTION

The frozen confectionery industry is constantly seeking to devise novel products that will appeal to consumers. Whilst frozen confectionery products, such as ice cream and water ices tend to be sold either in containers, e.g. tubs of ice cream or cartridge dispensers, or as individually wrapped items such as ice lollies/popsicles, a relatively recent product innovation is in the form of single serve containers filled with a plurality of ice cream beads. The beads are manufactured by a process which involves feeding uniformly sized drops of a liquid composition into a freezing chamber, typically filled with liquid nitrogen.

Part of the consumer appeal with these bead products is that they are intended to have free-flowing characteristics. In other words, a portion of beads can be poured out from the container. However, a problem that arises is that unless the beads are stored at very low temperatures, typically below about −29° C., the beads become tacky and stick together and sinter, and are no longer free-flowing. In addition, if the beads are not stored at these very temperatures, they become soft and deform, especially those at the bottom of the container. It is not typically possible to maintain such low temperatures throughout the cold chain, especially at the point of retail and so the shelf life of the product is reduced and its appearance at point of sale unsatisfactory.

### SUMMARY OF THE INVENTION

We have now found that the addition of ice structuring proteins to frozen dairy confectionery products reduces their tendency to stick and allows the production of free flowing frozen confectionery products that maintain their free-flowing characteristics for longer and at higher storage temperatures then existing products. The appearance of such products is significantly improved compared to existing products even after storage at temperatures above about −20° C. for several weeks.

Accordingly, the present invention provides a frozen confectionery product comprising a plurality of discrete unaerated dairy frozen confections, each discrete frozen confection being able to contact directly other discrete frozen confections in the product, which frozen confections comprise an ice structuring protein (ISP) and have an average volume of less than 1 ml.

Preferably the product comprises at least 10 discrete frozen confections, such as at least 20, 50 or 100 discrete frozen confections.

In a preferred embodiment the discrete frozen confections have an average volume of less than 0.5 ml. The frozen confections may, for example, be in the form of beads.

Preferably the dairy product comprises at least about 3 wt % of milk solids non-fat (MSNF). For example, the product can be selected from ice cream, frozen yoghurt or milk ice. Preferably the product comprises at least about 15 wt % solids. Typically, the product comprises from about 2 wt % to 15 wt % fat.

In a related aspect, the present invention provides a product comprising a container filled with a frozen confectionery product of the invention. Preferably, the container has a volume of from about 100 ml to about 1000 ml.

The present invention also provides a retail unit comprising a plurality of containers, each container comprising a product of the invention wherein the product in each container is different.

### DETAILED DESCRIPTION OF THE INVENTION

Unless defined otherwise, all technical and scientific terms used herein have the same meaning as commonly understood by one of ordinary skill in the art (e.g. in frozen confectionery manufacture, molecular biology and biochemistry). Definitions and descriptions of various terms and techniques used in frozen confectionery manufacture are found in Ice Cream, 4^{th} Edition, Arbuckle (1986), Van Nostrand Reinhold Company, New York, N.Y. Standard techniques are used for molecular and biochemical methods (see generally, Sambrook et al., Molecular Cloning: A Laboratory Manual, 3^{rd ed. (}2001) Cold Spring Harbor Laboratory Press, Cold Spring Harbor, N.Y. and Ausubel et al., Short Protocols in Molecular Biology (1999) 4^{th} Ed, John Wiley & Sons, Inc.—and the full version entitled Current Protocols in Molecular Biology).

### Ice Structuring Proteins

Ice structuring proteins (ISPs) are proteins that can influence the shape and size of the crystals of ice formed when freezing does occur, and inhibit recrystallisation of ice (Clarke et al., 2002, Cryoletters 23: 89-92). Many of these proteins were identified originally in organisms that live in sub-zero environments and are thought to protect the organism from the deleterious effects of the formation of ice crystals in the cells of the organism. For this reason many ice structuring proteins are also known as antifreeze proteins (AFPs). In the context of the present invention, an ISP is defined as a protein that has ice recrystallisation inhibitory (RI) activity.

Ice recrystallisation inhibitory activity properties can conveniently be measured by means of a modified splat assay as described in WO00/53029:

2.5 μl of the solution under investigation in 30% (w/w) sucrose is transferred onto a clean, appropriately labelled, 16 mm circular coverslip. A second coverslip is placed on top of the drop of solution and the sandwich pressed together between finger and thumb. The sandwich is dropped into a bath of hexane held at −80° C. in a box of dry ice. When all sandwiches have been prepared, sandwiches are transferred from the −80° C. hexane bath to the viewing chamber containing hexane held at −6° C. using forceps pre-cooled in the dry ice. Upon transfer to −6° C., sandwiches can be seen to change from a transparent to an opaque appearance. Images are recorded by video camera and grabbed into an image analysis system (LUCIA, Nikon) using a 20× objective. Images of each splat are recorded at time=0 and again after 60 minutes. The size of the ice-crystals in both assays is compared by placing the slides within a temperature controlled cryostat cabinet (Bright Instrument Co Ltd, Huntington, UK). Images of the samples are transfered to a Quantimet 520 MC image analysis system (Leica, Cambridge UK) by means of a Sony monochrome CCD videocamera.

Ice crystal sizing can be performed by hand-drawing around the ice-crystals. Typically, at least 100 to 400 crystals are sized for each sample. The ice crystal size is taken as being the longest dimension of the 2D projection of each crystal. The average crystal size is determined as the number average of the individual crystal sizes. The size of the ice-crystals in both assays is compared. If the size at 30-60 minutes is similar or only moderately (less than 10%) increased compared to the size at t=0, and/or the crystal size is less than 20 micrometer, preferably from 5 to 15 micrometer this is an indication of good ice-crystal recrystallisation properties.

Significant ice recrystallisation inhibitory activity can be defined as where a 0.01 wt % solution of the ISP in 30 wt % sucrose, cooled rapidly (at least Δ50° C. per minute) to −40° C., heated rapidly (at least Δ50° C. per minute) to −6° C. and then held at this temperature results in an increase in average ice crystal size over one hour of less than 5 μm.

### Types of ISPs

ISPs for use according to the present invention can be derived from any source provided they are suitable for inclusion in food products. ISPs have been identified to date in fish, plants, lichen, fungi, micro-organisms and insects. In addition, a number of synthetic ISPs have been described.

Examples of fish ISP materials are AFGP (for example obtainable from Atlantic cod, Greenland cod and Tomcod), Type I ISP (for example obtainable from Winter flounder, Yellowtail flounder, Shorthorn sculpin and Grubby sculpin), Type II ISP (for example obtainable from Sea raven, Smelt and Atlantic herring) and Type III ISP (for example obtainable from Ocean pout, Atlantic wolffish, Radiated shanny, Rock gunnel and Laval's eelpout).

Type III ISPs are particularly preferred. Type III ISPs typically have a molecular weight of from about 6.5 to about 14 kDa, a beta sandwich secondary structure and a globular tertiary structure. A number of genes encoding type III ISPs have been cloned (Davies and Hew, 1990, FASEB J. 4: 2460-2468). A particularly preferred type III ISP is type III HPLC-12 (Accession No. P19614 in the Swiss-Prot protein database).

Lichen AFPs are described in WO99/37673 and WO01/83534.

Examples of plants in which ISPs have been obtained are described in WO98/04699 and WO98/4148 and include garlic-mustard, blue wood aster, spring oat, winter cress, winter canola, Brussels sprout, carrot (GenBank Accession No. CAB69453), Dutchman's breeches, spurge, daylily, winter barley, Virginia waterleaf, narrow-leaved plantain, plantain, speargrass, Kentucky bluegrass, Eastern cottonwood, white oak, winter rye (Sidebottom et al., 2000, Nature 406: 256), bittersweet nightshade, potato, chickweed, dandelion, spring and winter wheat, triticale, periwinkle, violet and grass.

The ISPs can be obtained by extraction from native sources by any suitable process, for example the isolation processes as described in WO98/04699 and WO98/4148.

Alternatively, ISPs can be obtained by the use of recombinant technology. For example host cells, typically micro-organisms or plant cells, may be modified to express ISPs and the ISPs may then be isolated and used in accordance with the present invention. Techniques for introducing nucleic acid constructs encoding ISPs into host cells are well known in the art.

Typically, an appropriate host cell or organism would be transformed by a nucleic acid construct that encodes the desired ISP. The nucleotide sequence coding for the polypeptide can be inserted into a suitable expression vector encoding the necessary elements for transcription and translation and in such a manner that they will be expressed under appropriate conditions (e.g. in proper orientation and correct reading frame and with appropriate targeting and expression sequences). The methods required to construct these expression vectors are well known to those skilled in the art.

A number of expression systems may be used to express the polypeptide coding sequence. These include, but are not limited to, bacteria, fungi (including yeast), insect cell systems, plant cell culture systems and plants all transformed with the appropriate expression vectors. Preferred hosts are those that are considered food grade—‘generally regarded as safe’ (GRAS).

Suitable fungal species include yeasts such as (but not limited to) those of the genera Saccharomyces, Kluyveromyces, Pichia, Hansenula, Candida, Schizo saccharomyces and the like, and filamentous fungal species such as (but not limited to) those of the genera Aspergillus, Trichoderma, Mucor, Neurospora, Fusarium and the like. Preferably the species selected is a yeast, most preferably a species of Saccharomyces such as S. cerevisiae. Where glycosylation of the ISP leads to reduced activity then it is preferred that the host exhibits reduced glycosylation of heterologous proteins.

A wide variety of plants and plant cell systems can also be transformed with the nucleic acid constructs of the desired polypeptides. Examples of plant species include maize, tomato, tobacco, carrots, strawberries, rape seed and sugar beet.

The sequences encoding the ISPs are preferably at least 80% identical at the amino acid level to an ISP identified in nature, more preferably at least 95% or 100% identical. However, persons skilled in the art may make conservative substitutions or other amino acid changes that do not reduce the RI activity of the ISP. For the purpose of the invention these ISPs possessing this high level of identity to an ISP that naturally occurs are also embraced within the term “ISPs”.

### Frozen Confectionery Products

Frozen dairy confections are confections that typically contain milk or milk solids, such as ice cream, milk ice, frozen yoghurt and sherbet. The term “milk” includes milk-substitutes such as soya milk, although milk derived from female mammals is preferred. Preferably the frozen dairy confection is an ice cream or milk ice.

Frozen confectionery products of the present invention comprise a plurality of discrete frozen confections. The frozen confections are not separated from one another by the use of wrappings or other non-edible packaging, or by compartmentalisation. Instead, the individual frozen confections are packaged such that they are able to contact directly other individual frozen confections. However, the individual confections are able to move relative to each other, in other words they are not immobilised within, for example, a matrix such as a coating.

In a highly preferred embodiment, the frozen confectionery product of the invention is free-flowing. Preferably, the frozen confectionery product of the invention remains free-flowing after storage at −10° C. for at least 10 days, more preferably at least 15 or 20 days.

The frozen confections are relatively small, for example having an average volume of less than 1 ml, more preferably less than 0.5 ml. By way of example, beads having a diameter of from 0.5 mm to 1 mm would have a volume of from about 0.065 ml to about 0.5 ml. Typically, the discrete frozen confections have a minimum average volume such that each confection can be readily distinguished by a consumer. For example, the discrete frozen confection preferably have a minimum average volume of at least about 0.02 ml.

The discrete frozen confections may be made to any shape, such as in the form of cubes or spheres. Preferably, the frozen confections are substantially spherical.

The frozen confections may be in the form of a composite product where at least one portion or region of the product, such as a core or layer, does not contain ISPs. An example of this would be a product containing a core of ice cream which lacks ISP, coated in a layer of ice cream or milk ice that does contain ISP. Preferably, substantially the outer layer of the composition confection comprises ISP, i.e. the region which will come into contact with other discrete frozen confections. It will be appreciated that in the case of a composite product, the wt % amount of ISP added is calculated solely in relation to those components of the confection that contain ISP and not in relation to the complete product.

The frozen confections are unaerated. By unaerated is meant a frozen confection having an overrun of less then 20%, preferably less than 10%. An unaerated frozen confection is not subjected to deliberate steps such as whipping to increase the gas content. Nonetheless, it will be appreciated that during the preparation of unaerated frozen confections, low levels of gas, such as air, may be incorporated in the product.

Frozen confections containing milk preferably contain at least about 3 wt % milk solid non-fat (MSNF), more preferably from about 5 wt % to about 25 wt % MSNF. Milk ices will generally comprise at least about 10 or 11 wt % MSNF. Ice cream generally comprises at least 18 or 20 wt % MSNF. Milk-containing frozen confections will also typically comprise at least 2 wt % fat. Milk ices will generally comprise less than 7 wt % fat whereas ice cream generally comprises at least 8 or 10 wt % fat. In some embodiments, it is preferred that the total fat content is less than 8 wt %, more preferably less than 6 wt %.

Frozen confections of the invention typically comprise one or more stabiliser, such as one or more stabilisers selected from gums, agar, alginates and derivatives thereof, gelatin, pectin, lecithin, sodium carboxymethylcellulose, carrageenan and furcelleran. Preferably a blend of stabilisers is used, such as blend of a gum and carrageenan. In a preferred embodiment, the frozen confection comprises from 0.1 to 1 wt % stabiliser.

Frozen confections of the invention typically comprise at least about 0.0005 wt % ISP. ISPs can be used at very low concentrations and therefore preferably the confections comprise less than 0.05 wt % ISP. A preferred range is from about 0.001 to 0.01 wt %, more preferably from 0.005 to 0.01 wt %.

Frozen confections of the invention can be manufactured using a number of techniques known in the art. For example, free-flowing beads can be manufactured by dispensing drops of the liquid mix into a freezing chamber of liquid nitrogen (see WO96/29896). Other shapes can be manufactured by moulding techniques, for example by introducing a liquid premix into a cooled mould. Alternatively, ice cream and the like can be introduced into the mould after the initial freezing stages when the ice cream is still soft, and then hardened in the mould. Moulded products may contain complex shapes and have a high degree of surface definition.

Ice cream products and the like need not be subjected to a cold hardening step of below from −20° C. to −25° C., although this may be used if desired, especially if the product is a composite product with a layer or core that does not contain ISP.

The frozen confectionery product of the invention may be packaged in containers for sale to consumers as an individual unit. The volume of such containers is typically from 100 ml to 1000 ml, such as from 200 ml to 500 ml. However, the product can also be packaged in larger containers for retail purposes where the product is dispensed into smaller containers at the retail premises, e.g. in fast food outlets or as a pick ‘n’ mix format where consumers can choose from frozen confections of the invention having different shapes, flavours and/or colours. These larger containers may, for example, have a volume greater than about 1000 ml, for example at least 2000 ml or 5000 ml.

The present invention will now be further described with reference to the following examples, which are illustrative only and non-limiting.

### EXAMPLES

### Examples 1 to 6 and Comparative Examples 1 to 5

Ice cream/milk ice beads

### Materials and Methods

Ice cream/milk ice premixes were produced according to the following recipes.

TABLE 1

| Ingredients | C. Ex. 1 | Ex. 1 | C. Ex. 2 | Ex. 2a | Ex. 2b | Ex. 2c |
|---|---|---|---|---|---|---|
| Milk source (I) | 5.0 | 5.0 | 10.8 | 10.8 | 10.8 | 10.8 |
| Fat source (II) | 4.0 | 4.0 | 2.5 | 2.5 | 2.5 | 2.5 |
| Sugar source | 8.5 | 8.5 | 6.6 | 6.6 | 6.6 | 6.6 |
| (III) | | | | | | |
| Stabiliser (IV) | 0.08 | 0.08 | 0.33 | 0.33 | 0.33 | 0.33 |
| Flavouring (V) | 0.006 | 0.006 | 0.012 | 0.012 | 0.012 | 0.012 |
| Emulsifier (VI) | 0.15 | 0.15 | 0.2 | 0.2 | 0.2 | 0.2 |
| Water | 82.26 | 83.33 | 79.56 | 80 | 80.66 | 81 |
| ISP (%) | 0 | 0.005 | 0 | 0.002 | 0.005 | 0.007 |
| MSNF (%) | 4.8 | 4.8 | 10.3 | 10.3 | 10.3 | 10.3 |
| Fat (%) | 4.2 | 4.2 | 2.8 | 2.8 | 2.8 | 2.8 |
| Total solids | 17 | 17 | 20 | 20 | 20 | 20 |
| (%) | | | | | | |
| Ingredients | C. Ex. 3 | Ex. 3 | C. Ex 4 | Ex. 4 | C. Ex. 5 | Ex. 5 |
| Milk source (I) | 12.45 | 12.45 | 10 | 10 | 11 | 11 |
| Fat source (II) | 2.5 | 2.5 | 8 | 8 | 9.6 | 9.6 |
| Sugar source | 14.5 | 14.5 | 17 | 17 | 17.2 | 17.2 |
| (III) | | | | | | |
| Stabiliser (IV) | 0.33 | 0.33 | 0.16 | 0.16 | 0.3 | 0.3 |
| Flavouring (V) | 0.012 | 0.012 | 0.012 | 0.012 | 0.012 | 0.012 |
| Emulsifier (VI) | 0.2 | 0.2 | 0.3 | 0.3 | 0.3 | 0.3 |
| Water | 70.00 | 71.06 | 64.53 | 65.66 | 61.59 | 62.65 |
| ISP (%) | 0 | 0.005 | 0 | 0.005 | 0 | 0.005 |
| MSNF (%) | 11.9 | 11.9 | 9.55 | 9.55 | 10.5 | 10.5 |
| Fat (%) | 2.8 | 2.8 | 8.4 | 8.4 | 10 | 10 |
| Total solids | 29.5 | 29.5 | 35 | 35 | 38 | 38 |
| (%) | | | | | | |

| Ingredients | Ex. 6 |
|---|---|
| Milk source (I) | 10.18 |
| Fat source (II) | 8.8 |
| Sugar source (III) | 10.6 |
| Stabiliser (IV) | 0.3 |
| Flavouring (V) | 0.012 |
| Emulsifier (VI) | 0.2 |
| Water | 70.96 |
| ISP (%) | 0.005 |
| MSNF (%) | 10.1 |
| TF (%) | 4.5 |
| TS (%) | 25.5 |

Key
(I) Milk protein source can be any typically used ice cream or milk ice ingredient such as SMP (skim milk powder).
(II) Any typically used ice cream or milk ice fat source such as coconut oil, butteroil or cream.
(III) Sugar source can be any typically used ice cream or milk ice ingredient such as either sucrose or a blend of sucrose/fructose in 60/40 ratio or sucrose/fructose in 98/2 ratio or 76/24 ratio of sucrose/MD40.
(IV) LBG (locust bean gum) or a blend of LBG/guar gum/carrageenan such as 90/0/10 or 61/30/9.
(V) Any typically used ice cream or milk ice flavourings.
(VI) Any typically used ice cream or milk ice emulsifier such as monoglycerolpalmitate (MGP) or glycerol monostearate (GMS).
TS indicates the total solids content as a percentage by weight.
TF indicates the total fat content (including emulsifier) as a percentage by weight.
MSNF indicates the milk solids non fat content as a percentage by weight

The determination of these values is conventional in the art

### Mix Process

All dry ingredients were added to water which was pre-heated to 80° C., followed by stirring for 5 minutes. Then all the liquid ingredients and acidifier were added, stored for 1 minute, pasteurised at 82° C. for 33 seconds, homogenised at 150-170 bar pressure and cooled to 5° C. until required. ISP was added post pasteurisation for the purposes of this study, addition pre-pasteurisation would require removal of an equal weight of water from the formulation.

### Particle Formation

The liquid mix at 5° C. was loaded into a mix chamber of 5 litres capacity which fed directly into a dripping nozzle of 1 mm internal diameter. The liquid drops in turn fell into liquid nitrogen where they were rapidly frozen into approximately spherical balls. From here they were filled into a cylindrical type cup (height 95 mm, bottom outside diameter 63 mm, top outside diameter 46 mm) to a fill weight of 85 g, from the base, the base being sealed on with an iron. The products were then placed at −25° C. until required for measurement.

### Free Flow Test

Samples are held at a constant temperature of either −10° C. or −25° C. for 50 days. Samples in a pot (six replicates) were squeezed manually at −25° C., the pot was then opened and upturned and the flow properties of the contents assessed on a 5 point scale according to which:

1=particles exit pot and are completely free flowing.

2=if particles do not exit at 1, pot is re-closed and inverted 5 times to separate the particles, which exit when the lid is opened and upturned.

3=as 2 but two gentle squeezes to the sides are additionally required before particles will exit. No residual deformation of the pack is seen.

4=as 3 but two harder squeezes are required which will deform the pack, leaving it still deformed after the particles are removed.

5=particles can not be made to exit.

A squeeze score of 3 is considered the maximum in terms of acceptable flowability. The scores quoted in Table 2 are mean values of the scores obtained for six replicate samples. The test was performed with respect to time, sampling every few days.

### Results

TABLE 2

| | |
|---|---|
| C. Ex 1 | Ex. 1 |
| Squeeze value | Squeeze value |

| Time (Days) | −10° C. | −25° C. | −10° C. | −25° C. |
|---|---|---|---|---|
| 1 | 3 | 2 | 3 | 2 |
| 2 | 4 | n.d | n.d | n.d |
| 3 | n.d | n.d | n.d | n.d |
| 4 | n.d | 3 | 3 | 3 |
| 5 | 5 | 3 | 4 | 3 |
| 7 | 5 | 3 | 4 | 3 |
| 10 | 5 | 3 | 3 | 3 |
| 15 | 5 | 3 | 5 | 3 |
| 21 | n.d | n.d | n.d | n.d |
| 30 | 5 | 3 | 5 | 3 |
| 40 | 5 | 3 | 5 | 3 |
| 50 | 5 | 4 | 5 | 3 |

| | C. Ex 2 | | Ex. 2a | | Ex. 2b | | Ex. 2c | |
|---|---|---|---|---|---|---|---|---|
| | Squeeze value | | Squeeze value | | Squeeze value | | Squeeze value | |
| Time (Days) | −10° C. | −25° C. | −10° C. | −25° C. | −10° C. | −25° C. | −10° C. | −25° C. |
| 1 | n.d | 1 | n.d | 1 | n.d | n.d | n.d | 1 |
| 2 | n.d | n.d | n.d | n.d | n.d | n.d | n.d | n.d |
| 3 | n.d | n.d | n.d | n.d | 3 | 2 | n.d | n.d |
| 4 | 3 | 2 | 3 | 2 | 3 | 1 | 3 | 2 |
| 5 | 3 | 1 | 3 | 1 | 3 | 1 | 3 | 1 |
| 7 | 3 | 1 | 3 | 1 | 3 | 1 | 3 | 1 |
| 10 | 3 | 2 | 3 | 2 | 3 | 1 | 3 | 2 |
| 15 | 4 | 3 | 3 | 2 | 3 | 1 | 3 | 3 |
| 21 | 4 | 1 | 4 | 2 | 3 | 2 | 3 | 1 |
| 30 | 3 | 2 | 3 | 2 | 4 | 3 | 3 | 1 |
| 40 | 4 | 2 | 4 | 2 | 3 | 2 | 4 | 2 |
| 50 | 4 | 3 | 4 | 2 | 4 | 3 | 4 | 2 |
| | C. Ex. 3 | | Ex. 3 | | C. Ex. 4 | | Ex. 4 | |
| | Squeeze value | | Squeeze value | | Squeeze value | | Squeeze value | |
| Time (Days) | −10° C. | −25° C. | −10° C. | −25° C. | −10° C. | −25° C. | −10° C. | −25° C. |
| 1 | n.d | 1 | 3 | 2 | n.d | n.d | n.d | n.d |
| 2 | n.d | n.d | n.d | 2 | n.d | n.d | n.d | n.d |
| 3 | 4 | 2 | n.d | 2 | 3 | 2 | 3 | 2 |
| 4 | 5 | 2 | n.d | n.d | 5 | 2 | 3 | 2 |
| 5 | 5 | 2 | 3 | n.d | n.d | n.d | n.d | 2 |
| 7 | 5 | 2 | 3 | 2 | 4 | 2 | n.d | 2 |
| 10 | 5 | 2 | 3 | 2 | 3 | 2 | 3 | 2 |
| 15 | 5 | 2 | 4 | 3 | 5 | 2 | 3 | 2 |
| 21 | 5 | 2 | 4 | 3 | 4 | 2 | 3 | 2 |
| 30 | 5 | 3 | 5 | 3 | 4 | 3 | 3 | 3 |
| 40 | 5 | 3 | 5 | 3 | 4 | 3 | 3 | 2 |
| 50 | 5 | 3 | 4 | 3 | 5 | 3 | 3 | 3 |

| | | |
|---|---|---|
| C. Ex. 5 | Ex. 5 | Ex. 6 |
| Squeeze value | Squeeze value | Squeeze value |

| Time (Days) | −10° C. | −25° C. | −10° C. | −25° C. | −10° C. | −25° C. |
|---|---|---|---|---|---|---|
| 1 | 5 | 2 | 3 | 1 | 3 | 1 |
| 2 | n.d | n.d | n.d | n.d | n.d | n.d |
| 3 | n.d | n.d | n.d | n.d | n.d | n.d |
| 4 | 4 | 2 | 3 | 2 | n.d | n.d |
| 5 | 4 | 3 | 4 | 2 | 3 | 1 |
| 7 | n.d | 3 | 3 | 2 | 3 | 2 |
| 10 | 5 | 3 | 3 | 2 | 4 | 2 |
| 15 | 5 | 3 | 4 | 2 | 4 | 3 |
| 21 | 5 | 3 | 3 | 2 | 4 | 3 |
| 30 | 5 | 3 | 4 | 3 | 4 | 3 |
| 40 | 5 | 3 | 4 | 3 | 3 | 2 |
| 50 | 5 | 3 | 4 | 3 | 4 | 3 |

Comparative Example 1 is a control sample at 17% TS, which does not contain ISP. After 50 days at −25° C., the sample was unacceptable. After 2 days at −10° C., the sample became unacceptable.

Example 1 contains 0.005% ISP at 17% TS. Sample is free flowing throughout the test at −25° C. After 5 days at −10° C., the sample remains free flowing and did not reach the same level of unacceptability as example 1a until day 15.

Comparative Example 2 is a control sample at 20% TS, which does not contain ISP. After 50 days at −25° C., the sample remained free flowing. After 15 days at −10° C. the sample became unacceptable.

Example 2a contains 0.002% ISP at 20% TS. The sample remained free flowing after 50 days −25° C. After 40 days at −10° C., the sample became unacceptable.

Example 2b contains 0.005% ISP at 20% TS. The sample remained free flowing after 50 days at −25° C. After 50 days at −10° C., the sample became unacceptable, showing marked improvement over comparative example 2 and example 2a.

Example 2c contains 0.007% ISP at 20% TS. After 50 days at −25° C., the sample remained free flowing. After 40 days at −10° C., the sample became unacceptable. This sample showed marked improvement over comparative example 2 and example 2a.

Comparative Example 3 is a control sample at 30% TS, which does not contain ISP. After 50 days at −25° C., the sample remained free flowing. After 3 days at −10° C., the sample became unacceptable.

Example 3 contains 0.005% ISP at 30% TS. After 50 days at −25° C., the sample remained free flowing. After 15 days at −10° C., the sample became unacceptable, showing marked improvement over the comparative example 3.

Comparative Example 4 is a control sample at 35% TS, which does not contain ISP. After 50 days, the sample remained free flowing. After 15 days at −10° C., the sample became unacceptable.

Example 4 contains 0.005% ISP at 35% TS. The sample remained free flowing after 50 days at both −25° C. and −10° C., showing marked improvement over comparative example 4.

Comparative Example 5 is a control sample at 35% TS, which does not contain ISP. After 50 days at −25° C., the sample remained free flowing. After 1 day at −10° C., the sample became unacceptable.

Example 5 contains 0.005% ISP at 35% TS. After 50 days at −25° C., the sample remained free flowing. After 30 days at −10° C., the sample became unacceptable, showing marked improvement over comparative example 5.

Example 6 contains 0.005% ISP at 25% TS. After 50 days at −25° C., the sample remained free flowing. After 10 days at −10° C., the sample became unacceptable.

In summary, it is readily apparent that the addition of ISP leads to a product with improved characteristics and which has improved storage stability, as evidenced by better flowability after storage at −10° C. than the corresponding product which lacks ISP.

The various features and embodiments of the present invention, referred to in individual sections above apply, as appropriate, to other sections, mutatis mutandis. Consequently features specified in one section may be combined with features specified in other sections, as appropriate.

All publications mentioned in the above specification are herein incorporated by reference. Various modifications and variations of the described methods and products of the invention will be apparent to those skilled in the art without departing from the scope of the invention. Although the invention has been described in connection with specific preferred embodiments, it should be understood that the invention as claimed should not be unduly limited to such specific embodiments. Indeed, various modifications of the described modes for carrying out the invention which are apparent to those skilled in the relevant fields are intended to be within the scope of the following claims.

1. A frozen confectionery product comprising a plurality of discrete unaerated dairy frozen confections, each discrete frozen confection being able to contact directly other discrete frozen confections in the product, which frozen confections comprise an ice structuring protein (ISP) and have an average volume of less than 1 ml.

2. A product according to claim 1 which comprises at least 10 discrete frozen confections.

3. A product according to claim 1 which comprises at least 100 discrete frozen confections.

4. A product according to any one of the preceding claims wherein the discrete frozen confections have an average volume of less than 0.5 ml.

5. A product according to any one of claims 1 to 4 which is an unaerated ice cream or milk ice.

6. A product according to claim 5 which comprises at least about 15 wt % solids.

7. A product according to claim 5 which comprises from about 2 wt % to 15 wt % fat.

8. A product according to any one of the preceding claims wherein the ISP is a fish type III ISP.

9. A product according to claim 8 wherein the ISP is type III AFP HPLC-12.

10. A product according to any one of the preceding claims wherein the frozen confections comprise at least 0.0005 wt % of the ISP.

11. A product comprising a container filled with a frozen confectionery product according to any one of claims 1 to 10.

12. A product according to claim 11 wherein the container has a volume of from 100 ml to 1000 ml.

13. A retail unit comprising a plurality of containers, each container comprising a product according to any one of claims 1 to 10 wherein the product in each container is different.
